(19) United States
(12) Patent Application Publication
(10) Pub. No.: US 2008/0311500 A1
(43) Pub. Date: Dec. 18, 2008

(54) TONER FOR DEVELOPING ELECTROSTATIC IMAGE, AND IMAGE FORMING APPARATUS AND PROCESS CARTRIDGE USING THE TONER

(76) Inventors: Masahide YAMADA, Numazu-shi (JP); Osamu Uchinokura, Mishima-shi (JP); Akinori Saitoh, Numazu-shi (JP); Junichi Awamura, Numazu-shi (JP); Tomomi Suzuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/042,041

(22) Filed: Mar. 4, 2008

(30) Foreign Application Priority Data
Mar. 16, 2007 (JP) 2007-068455

(51) Int. Cl. G03G 9/08; G03G 9/087; G03G 9/09; G03G 5/00; G03G 15/08

(52) U.S. Cl. 430/105; 430/108.8; 430/110.3; 430/111.4; 430/137.22; 399/222

(57) ABSTRACT

A toner including toner particles including a binder resin; a colorant, a release agent, and a modified layered inorganic material in which at least part of interlayer ions is modified with an organic ion, wherein the toner includes the release agent in an amount of from 3 to 6% by weight based on the total weight of the toner, and concentration of the modified layered inorganic material in a surface portion of the toner is greater than the average concentration thereof in the toner, and wherein the toner is subjected to FTIR-ATR, the ratio (P2850/P828) of the strength of the peak at 2850 cm⁻¹ to that of the peak at 828 cm⁻¹, is from 0.03 to 0.10. An image forming apparatus and a process cartridge which form a toner image using the toner.

### BACKGROUND OF THE INVENTION

1. Field of the Invention

The present invention relates to a toner for use in developing an electrostatic image. In addition, the present invention also relates to an image forming apparatus and a process cartridge which form visual images using the toner.

2. Discussion of the Background

Recently, a need exists for an electrophotographic image forming apparatus which can produce high quality images. In attempting to fulfill the need, various electrophotographic image forming apparatuses and toners have been proposed and developed. In order to produce high quality images with a toner, the toner preferably has a sharp particle diameter distribution. Specifically, when a toner has a sharp particle diameter distribution, the toner particles can exhibit almost the same behavior in an image developing process, and thereby images with improved fine dot reproducibility can be produced.

However, conventional toners having a relatively small particle diameter and a relatively sharp particle diameter distribution tend to cause a cleaning problem in that toner particles remaining on the surface of an image bearing member (such as photoreceptors and intermediate transfer belts) cannot be well removed with a cleaning blade, resulting in formation of images with background development. In attempting to solve the cleaning problem on the toner side, various proposals have been made. For example, a toner whose particle form is changed from the spherical form to irregular forms (this particle form change is hereinafter sometimes referred to as deformation) is proposed. By deforming a toner, the fluidity of the toner deteriorates and thereby toner particles remaining on an image bearing member can be blocked with a cleaning blade. Therefore, the residual toner particles can be well removed with the blade. However, when deformation of a toner is excessively performed, the behavior of the toner particles thereof becomes unstable, resulting in deterioration of the fine dot reproducibility of the toner.

In addition, by deforming a toner, the fixability of the toner tends to deteriorate although the cleanability thereof is improved. Specifically, a toner layer constituting a toner image has low density (i.e., there are many voids in the toner layer), and therefore the toner layer has low heat conductivity, resulting in deterioration of the low temperature fixability of the toner. This phenomenon is remarkable when the fixing pressure is relatively low.

Published unexamined Japanese patent application No. (hereinafter referred to as JP-A) 11-133665 discloses a toner constituted of a polyester resin and having a Wadell working sphericity of from 0.90 to 1.00. This toner has substantially spherical form, and therefore the toner has poor cleanability.

When toner particles are prepared by polymerization methods, suspension polymerization methods, emulsion polymerization methods and solution suspension methods can be typically used. Among these methods, the emulsion polymerization methods and solution suspension methods can easily produce deformed toner particles. However, emulsion polymerization methods have a drawback in that residual monomers (such as styrene monomer), emulsifiers and dispersants cannot be perfectly removed from the reaction product. Such toner pollutes the environmental.

When toner particles having projected portions and recessed portions are mixed with an external additive (i.e., fluidizer) such as silica, particles of the external additive adhered to the projected portions tend to move to recessed portions after long repeated used because adhesiveness of the external additive to projected portions is relatively weak compared to adhesiveness thereof to recessed portions. In this case, the toner contaminates the image bearing members such as photoreceptors and fixing members such as fixing rollers, resulting in deterioration of image qualities and occurrence of a jamming problem in that a receiving material sheet hearing a toner image thereon is jammed in a fixing device.

The solution suspension methods, in which a toner composition liquid prepared by dissolving or dispersing toner constituents in an organic solvent is granulized in an aqueous medium to prepare toner particles, have an advantage in that polyester resins, which have relatively good low temperature fixability compared to other resins, can be used as the binder resin of the toner. In the solution suspension methods, a high molecular weight component is included in a toner composition liquid and therefore the toner composition liquid tends to have a high viscosity. Therefore, the solution suspension methods tend to have a production problem in that toner particles cannot be easily prepared. JP-A 09-15903 discloses a toner, which has spherical form and whose surface is roughened to have asperities, in attempting to impart good cleanability to the toner. However, the asperities of the surface of the toner do not have regularity, and therefore the toner has poor charge stability. In addition, controlling and optimization of molecular weight of the binder resin of the toner is not performed, and therefore a good combination of durability and releasability cannot be imparted to the toner.

Toner can also be prepared by pulverization methods. Pulverization methods typically includes the steps of kneading toner constituents such as binder resins, colorants and additives (such as charge controlling agents) upon application of heat thereto, pulverizing the kneaded mixture, and then classifying the pulverized mixture to prepare toner particles. The pulverization methods have the following drawbacks.

(1) toner having a small average particle diameter cannot be provided (i.e., the particle diameter has a certain lower limit);
(2) it is impossible to properly position toner constituents in toner particles (for example, to position a charge controlling agent in a surface portion); and
(3) when the added amount of a charge controlling agent is increased, a filming problem in that a film of the charge controlling agent is formed on the surface of carrier particles used for the developer and/or image bearing members, resulting in deterioration of image qualities and occurrence of a fixing problem in that toner images cannot be firmly fixed to receiving materials particularly at a low fixing temperature are caused.

PCT patent application publications Nos. 2003-515795 (i.e., WO01/040878 or U.S. Pat. No. 7,309,558), 2006-500605 (i.e., WO2004/019138 or US20050277040) and 2006-503313 (i.e., WO2004/019137 or US20060020069), and JP-A 2003-202708 have disclosed to use layered inorganic materials, in which part of interlayer ions (such as metal cations) is modified with an organic cation, as charge controlling agents of toners. However, the toners including such layered inorganic materials also have the drawbacks mentioned above.

On the other hand, a technique in that a wax is included in toner as a release agent is proposed to impart good releasability from fixing members to the toner. However, such a toner often causes a problem in that the wax is adhered to image forming members such as photoreceptors when image forming operations are repeated for a long period of time, resulting in deterioration of image qualities. Therefore, it is a problem to be solved that a good releasability is imparted to a toner while preventing adhesion of the wax included in the toner to image forming members. To decrease the content of a wax in toner can prevent occurrence of the wax adhesion problem, but deteriorates the releasability of the toner. In addition, to miniaturize the size of particles (i.e., domain) of a wax dispersed in toner particles also prevents occurrence of the wax adhesion problem, but deteriorates the releasability of the toner.

Because of these reasons, a need exists for a toner, which can produce high quality images over a long period of time without causing the wax adhesion problem and fixing problem.

### SUMMARY OF THE INVENTION

As an aspect of the present invention, a toner is provided which includes toner particles including at least a binder resin, a colorant, a release agent, and a modified layered inorganic material in which at least part of interlayer ions is modified with an organic ion. The toner includes the release agent in an amount of from 3 to 6% by weight based on the total weight of the toner, and the concentration of the modified layered inorganic material in a surface portion of the toner is greater than the average concentration thereof in the entire portion of the toner (i.e., the modified layered inorganic material is eccentrically present in a surface portion of the toner). Further, the toner satisfies the following relationship:

0.03≦(P2850/P828)≦0.10,

wherein P2850 and P828 represent the strengths of peaks observed at wavenumbers of 2850 cm⁻¹ and 828 cm⁻¹, respectively, when the toner is subjected to Fourier Transform Infrared Spectroscopy-Attenuated Total Reflection (i.e., FTIR-ATR).

In this regard, the toner particles are preferably prepared by a method including the step of emulsifying or dispersing a toner composition including at least the binder resin, the colorant, the release agent and the modified layered inorganic material in an aqueous medium. Further, the toner particles are preferably prepared by a method including the steps of dissolving or dispersing a toner composition including at least a precursor of the binder resin and/or the binder resin, and the colorant, the release agent and the modified layered inorganic material in a solvent to prepared an oil phase liquid; dispersing the oil phase liquid in an aqueous medium to prepare an emulsion; optionally heating the emulsion to change the precursor to the binder resin; and removing the solvent from the emulsion to prepare a dispersion of the toner particles. In this regard, examples of the precursor include reactive polymers such as prepolymers, which can form binder resins by performing, for example, polymerization, molecular weight growth reaction and/or crosslinkage.

As another aspect of the present invention, an image forming apparatus is provided which includes at least an image bearing member configured to bear an electrostatic image thereon; a developing device configured to develop the electrostatic image with a developer including the toner mentioned above to form a toner image on the image bearing member; a transfer device configured to transfer the toner image on a receiving material optionally via an intermediate transfer medium; and a fixing device configured to fix the toner image on the receiving material.

As yet another aspect of the present invention, a process cartridge is provided which includes at least an image bearing member configured to bear an electrostatic image thereon; and a developing device configured to develop the electrostatic image with a developer including the toner mentioned above to form a toner image on the image bearing member, wherein the process cartridge is detachably attached to an image forming apparatus as a unit. The developing device can optionally include other devices such as charging devices and cleaning devices.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an example of the image forming apparatus of the present invention;

FIG. 2 is an enlarged view illustrating the image forming section of the image forming apparatus illustrated in FIG. 1; and

FIG. 3 is a schematic view illustrating an example of the process cartridge of the present invention.

### DETAILED DESCRIPTION OF THE INVENTION

The toner of the present invention includes a binder resin, a colorant, a release agent such as waxes, and a modified layered inorganic material in which at least part of interlayer ions is modified with an organic ion.

Such modified layered inorganic materials have a proper hydrophobicity and a proper hydrophilicity. Therefore, when toner particles are prepared in an aqueous medium using at least a binder resin, a colorant, a release agent and a modified layered inorganic material, the modified layered inorganic material tends to be eccentrically located in a surface portion of the toner particles. Specifically, unmodified layered inorganic materials have a good hydrophilicity. By modifying such unmodified layered inorganic materials with an organic ion, the resultant modified layered inorganic materials have a hydrophobicity. However, the modified layered inorganic materials do not perfectly lose the hydrophilicity, and have slight hydrophilicity. Therefore, when toner particles are prepared in an oil phase liquid dispersed in an aqueous phase liquid, the modified layered inorganic material included in toner particles in the oil phase liquid tends to be present near the interface between the oil phase liquid and the aqueous phase liquid, resulting in formation of toner particles in which the modified layered inorganic material is eccentrically located in a surface portion of the toner particles. Thereby, the amount of the exposed wax, which is present on the surface of the toner particles, can be decreased. The degree of the hydrophobicity (or hydrophilicity) of modified layered inorganic materials can be adjusted by changing the organic ion and the degree of replacement of the interlayer ions with the organic ion.

Whether a modified layered inorganic material is eccentrically present in a surface portion of a toner can be determined by subjecting the toner to an X-ray Photoelectron Spectroscopic (XPS) analysis. The XPS method can detect atoms present in a surface portion of a particle (toner particle) having a depth of about tens of nanometers. Specifically, the XPS method is as follows.

(1) A toner is subjected to an X-ray Photoelectron Spectroscopic (XPS) analysis to determine the concentration (A) (in units of atomic percent) of an atom specific to the modified layered inorganic material;
(2) The toner is kneaded upon application of heat thereto so that the toner constituents are evenly distributed in the kneaded toner; and
(3) the kneaded toner is also subjected to the X-ray Photoelectron Spectroscopic (XPS) analysis to determine the concentration (B) (in units of atomic percent) of the atom specific to the modified layered inorganic material.

In this regard, satisfaction of a relationship A>B shows that the modified layered inorganic material is eccentrically located in a surface portion of the toner particles.

The amount of a wax present in a surface portion of toner particles can be determined by a Fourier Transform Infrared-Attenuated Total Reflection (i.e., FTIR-ATR) method. Specifically, the amount of a wax present in a surface portion can be represented by the ratio (P2850/P828) of the intensity of the peak observed at a wavenumber of 2850 cm⁻¹ to the intensity of the peak observed at a wavenumber of 828 cm⁻¹. When the ratio is from 0.03 to 0.10, the resultant toner has good releasability without causing the wax adhesion problem.

The reason therefor is not yet determined but is considered to be as follows. Specifically, the peak at 2850 cm⁻¹ is caused by a wax included in the toner, and the peak at 828 cm⁻¹ is caused by an aromatic group included in a polyester resin serving as a binder resin of the toner. By controlling the ratio so as to fall in the above-mentioned range, the amount of the wax present in a surface portion of the toner can be controlled. When the ratio is less than 0.03, the releasability of the toner from fixing members tends to deteriorate. In contrast, when the ratio is greater than 0.10, the wax adhesion problem tends to be caused.

Thus, by adding a modified layered inorganic material to the toner while controlling the ratio (P2850/P828), a toner, which has good releasability and which hardly causes the wax adhesion problem, can be provided.

When preparing toner particles in an aqueous medium, the toner composition liquid (i.e., oil phase liquid) to be dispersed in the aqueous medium is prepared by dissolving or dispersing toner constituents (such as binder resins, binder resin precursors (such as reactive polymers (e.g., prepolymers) capable of forming binder resins), colorants, release agents and modified layered inorganic materials) in a solvent preferably including an organic solvent. The organic solvent used is preferably removed after or during the toner particle preparation process.

Suitable organic solvents for use in the oil phase liquid include volatile solvents having a boiling point lower than 150° C. so as to be easily removed from the emulsion in which the oil phase liquid is dispersed in an aqueous medium. Specific examples of such volatile solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination. Among these organic solvents, toluene, xylene, benzene, methylene chloride, 1,2-dichloroethane, chloroform, carbon tetrachloride and ethyl acetate are preferably used, and ethyl acetate is more preferably used. Although the content of the organic solvent in the oil phase liquid is determined depending on the targeted properties of the resultant toner particles, the weight ratio of the organic solvent to the total weight of the toner constituents is generally from 40/100 to 300/100, preferably from 6/100 to 140/100 and more preferably from 80/100 to 120/100.

The oil phase liquid can include materials other than binder resins, colorants, release agents and modified layered inorganic materials. For example, reactive polymers (e.g., prepolymers), and combinations of a compound having active hydrogen and a polymer (prepolymer) reactive with such a compound can be used for the binder resin. These reactive polymers are hereinafter referred to as precursors. In this case, the materials are subjected to one or more of polymerization reactions, molecular weight growth reactions and crosslinking reactions in the emulsion to prepare a binder resin of the toner particles.

Layered inorganic materials are defined as inorganic minerals in which layers having a thickness of few nanometers are overlaid. Modifying the materials with organic ions means that one or more organic ions are incorporated as interlayer ions. This incorporation is called intercalation. Intercalation is explained in detail in PCT application publications Nos. WO01/040878, WO2004/019138 and WO2004-019137. Specific examples of the layered inorganic materials include smectite family (e.g., montmorillonite and saponite), kaolin family (e.g., kaolinite), magadiite, and kanemite. Because of having a layered structure, the layered inorganic materials have good hydrophilicity. When an unmodified layered inorganic material is included in a toner composition liquid (i.e., oil phase liquid) and the toner composition liquid is dispersed in an aqueous medium to prepare toner particles, the material is migrated into the aqueous medium, and thereby deformation of toner particles cannot be performed (i.e., spherical toner particles are formed and toner particles having forms other than spherical form (i.e., irregular forms) cannot be prepared). In contrast, when a modified layered inorganic material, which has a less hydrophilicity (i.e., greater hydrophobicity) than unmodified layered inorganic materials, is used, the material forms fine toner particles with irregular forms in the granulation process (i.e., the toner particle preparation process). In addition, the material tends to be present in a surface portion of the resultant toner particles, and thereby a good charge controlling function of the modified layered inorganic material can be imparted to the toner. The added amount of a modified layered inorganic material in the toner composition liquid is preferably from 0.05 to 5%, and more preferably from 0.05 to 2%, by weight based on the total weight of the solid components included in the toner composition liquid.

The modified layered inorganic material for use in the toner of the present invention is preferably a layered inorganic material having a smectite crystal form and modified by an organic cation. In addition, it is possible to replace a divalent metal ion of the layered inorganic material with a trivalent metal ion. In this case, an organic anion is preferably incorporated in the layered inorganic material to attain ionic balance. The layered inorganic materials thus modified with an organic anion can also be used.

Suitable organic compounds for use in incorporating organic ions in layered inorganic materials include quaternary alkyl ammonium salts, phosphonium salts, imidazolium salts, etc. Among these compounds, quaternary alkyl ammonium salts are preferable. Specific examples of the quaternary alkyl ammonium salts include trimethylstearyl ammonium, dimethylstearylbenzyl ammonium, dimethyloctadecyl ammonium, oleylbis(2-hydroxyethyl)methyl ammonium, etc.

Specific examples of other organic compounds for use in incorporating organic ions include sulfates, sulphonates, carboxylates, and phosphates having a group (or a structure) such as linear, branched or cyclic alkyl groups (C1-C44), alkenyl groups (C1-C22), alkoxyl groups (C8-C32), hydroxyalkyl groups (C2-C22), ethylene oxide structures, and propylene oxide structures. Among these compounds, carboxylic acids having an ethylene oxide structure are preferably used.

When at least part of interlayer ions of a layered inorganic material is modified with one or more organic ions, the modified layered inorganic material has a proper hydrophobicity. By including such a modified layered inorganic material in a toner composition liquid, the toner composition liquid has a non-Newtonian viscosity, and thereby deformed toner particles can be prepared. As mentioned above, the added amount of a modified layered inorganic material in the toner composition liquid is preferably from 0.05 to 5%, and more preferably from 0.05 to 2%, by weight based on the total weight of the solid components included in the toner composition liquid. Modified versions of layered inorganic materials such as montmorillonite, bentonite, hectolite, hectorite, attapulgite, sepiolite, and mixtures of these materials are preferably used. Among these materials, modified montmorillonite and bentonite are preferably used because the modified versions of these materials can easily adjust the viscosity of a toner composition liquid even in a small added amount without deteriorating the properties of the resultant toner.

Specific examples of the marketed products of organic-cation-modified layered inorganic materials include quaternium 18 bentonite such as BENTONE 3, BENTONE 38, BENTONE 38V, (from Elementis Specialties), THIXOGEL VP (from United Catalyst), CLAYTON 34, CLAYTON 40, and CLAYTON XL (from Southern Clay Products); stearalkoniumbentonite such as BENTONE 27 (from Elementis Specialties), THIXOGEL LG (from United Catalyst), CLAYTON AF and CLAYTON APA (from Southern Clay Products); quaternium 18/benzalkonium bentonite such as CLAYTON HT and CLAYTON PS (from Southern Clay Products), etc. Among these materials, CLAYTON AF and CLAYTON APA are preferably used.

Specific examples of the marketed products of organic-anion-modified layered inorganic materials include materials which are prepared by modifying DHT-4A (from Kyowa Chemical Industry Co., Ltd.) with a material having the following formula (I) (such as HITENOL 330T from Dai-ichi Kogyo Seiyaku Co., Ltd.).

R₁(OR₂)ₙOSO₃M (1)

wherein R₁ represents an alkyl group having 13 carbon atoms; R₂ represents an alkylene group having 2 to 6 carbon atoms; n is an integer of from 2 to 10, and M represents a monovalent metal element.

The toner of the present invention preferably has a ratio (Dv/Dn) of the volume average particle diameter (Dv) to the number average particle diameter (Dn) of from 1.00 to 1.30. In this case, the toner can produce high quality and high definition images. In addition, variation of the particle diameter distribution of the toner is little and therefore the toner can maintain good developability even when the toner is agitated for a long period of time in a developing device while a fresh toner is supplied thereto.

The toner of the present invention preferably has a volume average particle diameter (Dv) of from 3.0 μm to 7.0 μm.

In general, using a toner having a small average particle diameter is advantageous to produce high definition and high quality images. However, such a small-sized toner is inferior in transferability and cleanability. When a toner having a volume average particle diameter smaller than the above-mentioned range is used for a two component developer, the toner tends to cause a toner adhesion problem in that the developer is fixedly adhered to a carrier after long term agitation, resulting in deterioration of the charging ability of the carrier. When such a small-sized toner is used as a one component developer, problems in that the toner forms a film on a developing roller, and the toner is fixedly adhered to members such as blades configured to form a thin toner layer on a developing roller tend to be caused. In addition, these phenomena are largely influenced by the content of fine toner particles in the toner. Specifically, when toner particles having a particle diameter of not greater than 2 μm are included in an amount of greater than 20% by number, the toner adhesion problem is seriously caused and in addition the charge stability of the toner seriously deteriorates. Therefore, the content of toner particles having a particle diameter of not greater than 2 μm in the toner is preferably not greater than 20% by number.

In contrast, when the volume average particle diameter of the toner is larger than the above-mentioned range, it is difficult to produce high definition and high quality images and in addition a problem in that the particle diameter distribution of the toner in a two-component developer largely changes when the toner is used while replenishing a fresh toner to the developer, resulting in variation of image qualities tends to occur.

As mentioned above, toner having a small particle diameter and a sharp particle diameter distribution has a poor cleanability and easily causes a cleaning problem. In this case, the circularity of the toner is preferably controlled so as to be from 0.93 to 0.97 to prevent occurrence of such a cleaning problem. The reason therefor will be explained below.

At first, the relationship between the shape of toner and transferability of the toner will be explained. In full color copiers, the amount of toner particles constituting a color image formed on an image bearing member (such as photoreceptors) is larger than that of toner particles constituting a black image. Therefore, it is difficult to improve the transfer efficiency by using conventional toners having irregular forms. Further, when a conventional toner having irregular forms is used, the toner tends to be fixedly adhered to the surfaces of the photoreceptor and intermediate transfer medium used (or a toner film is formed on the surfaces) due to friction therebetween, resulting in deterioration of transferability of toner images. Particularly, in full color image forming apparatus, four color toner images cannot be evenly transferred to an intermediate transfer medium, thereby producing full color images with poor evenness and color balance. Namely, high quality full color images cannot be produced.

In order to balance the blade cleanability with transfer efficiency of a toner, it is preferable for the toner to have a circularity of from 0.93 to 0.97. Although the cleanability of toner changes depending on the material used for the blade and the angle at which the blade is contacted with the image bearing member, and the transferability of toner changes depending on the transfer conditions, the toner of the present invention can have a good combination of cleanability and transferability when the toner has a circularity of from 0.93 to 0.97. When the circularity is too large, the cleanability of the toner deteriorates. In contrast, when the circularity is too small, transferability of the toner deteriorates.

The acid value of the toner is an important factor. The toner of the present invention preferably has an acid value of from 0.5 mgKOH/g to 40.0 mgKOH/g, which is mainly imparted to the toner by the carboxyl groups of the unmodified polyester resin used as a binder resin. In this case, the toner has a good combination of low temperature fixability and hot offset resistance. Namely, the acid value of the unmodified polyester resin used as a binder resin is preferably controlled so as to be from 0.5 mgKOH/g to 40 mgKOH/g to impart good combination of low temperature fixability and hot offset resistance to the toner. Specifically, when the acid value of the toner (the unmodified polyester resin) is too large, the molecular weight growth reaction or crosslinking reaction of the precursor of the binder resin such as prepolymers is insufficiently performed, resulting in deterioration of the hot offset resistance of the toner. In contrast, when the acid value is too small, the toner constituents cannot be well dispersed, and therefore the molecular weight growth reaction or crosslinking reaction of the precursor excessively proceeds, resulting in occurrence of a problem in the toner manufacturing processes. The acid value of the toner is measured by a method defined in JIS K0070.

The toner of the present invention preferably has a glass transition temperature of from 40° C. to 70° C. In this case, the toner has a good combination of low temperature fixability, high temperature fixability and durability. When the glass transition temperature of the toner is too low, the toner causes a blocking problem in that the toner particles aggregate in a developing device and a filming problem in that a film of the toner is formed on the surface of a photoreceptor. In contrast, when the glass transition temperature of the toner is too high, the low temperature fixability of the toner deteriorates.

The toner of the present invention can include a release agent. The content of the release agent in the toner is preferably from 1% to 10% by weight. When the content is too low, a good releasability cannot be imparted to the toner, resulting in deterioration of the fixability of the toner. In contrast, when the content is too high, the filming problem in that a film of the release agent is formed on the surface of carrier particles used for the developer and/or image bearing members, resulting in deterioration of image qualities occurs. Among various releasing agents, waxes having a melting point of from 50° C. to 120° C. are preferably used. When such a wax is included in the toner, the wax is dispersed in the binder resin and serves as a release agent while being present at a location between a fixing roller and the toner particles in the fixing process. Thereby the hot offset problem can be avoided without applying a release agent (such as oils) to the fixing roller used. In the present application, the melting point of a wax is defined as the temperature at which a maximum endothermic peak is observed in a differential scanning calorimetry (DSC). Among various waxes, paraffin waxes are preferably used as the release agent.

The toner of the present invention includes a colorant. Suitable materials for use as the colorant include known dyes and pigments.

Specific examples of the dyes and pigments include carbon black, Nigrosine dyes, black iron oxide, NAPHTHOL YELLOW S, HANSA YELLOW 10G, HANSA YELLOW 5G, HANSA YELLOW G, Cadmium Yellow, yellow iron oxide, loess, chrome yellow, Titan Yellow, polyazo yellow, Oil Yellow, HANSA YELLOW GR, HANSA YELLOW A, HANSA YELLOW RN, HANSA YELLOW R, PIGMENT YELLOW L, BENZIDINE YELLOW G, BENZIDINE YELLOW GR, PERMANENT YELLOW NCG, VULCAN FAST YELLOW 5G, VULCAN FAST YELLOW R, Tartrazine Lake, Quinoline Yellow LAKE, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED F2R, PERMANENT RED F4R, PERMANENT RED FRL, PERMANENT RED FRLL, PERMANENT RED F4RH, Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS, INDANTHRENE BLUE BC, Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1% to 15% by weight, and more preferably from 3% to 10% by weight of the toner.

Master batches, which are complexes of a colorant with a resin (binder resin), can be used as the colorant of the toner of the present invention.

Specific examples of the resins for use as the binder resin of the master batches include the modified and unmodified polyester resins, styrene polymers and substituted styrene polymers such as polystyrene, poly-p-chlorostyrene and polyvinyltoluene; styrene copolymers such as styrene—p-chlorostyrene copolymers, styrene—propylene copolymers, styrene—vinyltoluene copolymers, styrene—vinylnaphthalene copolymers, styrene—methyl acrylate copolymers, styrene—ethyl acrylate copolymers, styrene—butyl acrylate copolymers, styrene—octyl acrylate copolymers, styrene—methyl methacrylate copolymers, styrene—ethyl methacrylate copolymers, styrene—butyl methacrylate copolymers, styrene—methyl α-chloromethacrylate copolymers, styrene—acrylonitrile copolymers, styrene—vinyl methyl ketone copolymers, styrene—butadiene copolymers, styrene—isoprene copolymers, styrene—acrylonitrile-indene copolymers, styrene—maleic acid copolymers and styrene—maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The master batches can be prepared by mixing one or more of the resins as mentioned above and one or more of the colorants as mentioned above, and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent, the mixture is kneaded to transfer the colorant to the resin side (i.e., the oil phase), and then the organic solvent (and water, if desired) is removed from the kneaded mixture can be preferably used because the resultant wet cake can be used as it is without being dried. When performing the mixing and kneading process, dispersing devices capable of applying a high shearing force such as three roll mills can be preferably used.

The toner of the present invention optionally includes a charge controlling agent. Known charge controlling agents for use in conventional toners can be used for the toner of the present invention.

Specific examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. These materials can be used alone or in combination.

Specific examples of the marketed charge controlling agents include BONTRON 03 (Nigrosine dye), BONTRON P-51 (quaternary ammonium salt), BONTRON S-34 (metal-containing azo dye), BONTRON E-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

The content of the charge controlling agent in the toner of the present invention is determined depending on the variables such as choice of binder resin, presence of additives, and dispersion method. In general, the content of the charge controlling agent is preferably from 0.1 parts to 10 parts by weight, and more preferably from 0.2 parts to 5 parts by weight, per 100 parts by weight of the binder resin included in the toner. When the content is too high, the charge quantity of the toner excessively increases, and thereby the electrostatic attraction between the developing roller and the toner increases, resulting in deterioration of fluidity and decrease of image density. When preparing toner particles by a pulverization method, the charge controlling agent and release agent can be mixed with a master batch and a binder resin to be melted and kneaded. When preparing toner particles by a granulation method (such as polymerization methods), the materials can be dissolved or dispersed in a solvent together with other toner constituents (such as colorants and binder resins) to prepare a toner composition liquid (i.e., an oil phase liquid).

Alternatively, the charge controlling agent can be fixed to the surface of toner particles including at least a colorant and a binder resin by a method in which particles of the charge controlling agent and toner particles are mixed in a container using a rotor. In this case, it is preferable that the container has no projection on the inner surface thereof and the peripheral speed of the rotor is from 40 m/sec to 150 m/sec.

The toner of the present invention preferably includes an external additive.

Inorganic fine particles are typically used as an external additive. Inorganic particulate materials having a primary particle diameter of from 5 nm to 2 μm, and preferably from 5 nm to 500 nm, are used. The surface area of the inorganic particulate materials is preferably from 20 m²/g to 500 m²/g when measured by a BET method.

The content of the inorganic particulate material in the toner is preferably from 0.01% to 5.0% by weight, and more preferably from 0.01% to 2.0% by weight, based on the total weight of the toner.

Specific examples of such inorganic particulate materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Among these materials for use as the external additive (i.e., fluidity imparting agent), combinations of a hydrophobized particulate silica and a hydrophobized particulate titanium oxide are preferably used. In this regard, the particle diameter of such hydrophobized particulate silica and hydrophobized particulate titanium oxide is preferably not greater than 50 nm. When using such an external additive, the electrostatic force and van der Waals force between the toner particles and the particles of the external additive are dramatically increased even when the toner (i.e., combination of the toner particles and particles of the external additive) is agitated in a developing device, and thereby a problem in that the external additive is released from the toner particles is hardly caused. Therefore, the toner can produce high quality images without omissions (i.e., white spots). In addition, the amount of residual toner particles remaining on the image bearing members can be reduced.

Particulate titanium oxide can impart good environmental stability and good image density stability to the toner but tends to deteriorate the charge rising property of the toner. Therefore, when the added amount of a particulate titanium oxide is larger than that of a particulate silica, the resultant toner tends to have a poor charge rising property. Therefore, the added amount of a particulate titanium oxide is preferably controlled so as to be from 0.3% to 1.5% by weight based on the total weight of the toner. In this case, the charge rising property of the toner is not deteriorated, and therefore the toner can produce high quality images without causing a toner scattering problem in that the toner is scattered around the developing device, resulting in contamination of the image forming members.

The toner of the present invention is preferably prepared by the following method in which toner particles are prepared in an aqueous medium. However, the preparation method is not limited thereto.

### Method for Preparing Toner in Aqueous Medium

A toner composition liquid (i.e., oil phase liquid), which is prepared by dissolving or dispersing toner constituents (such as binder resins and/or precursors thereof), and modified layered inorganic materials, colorants and additives) in a solvent, is dispersed in an aqueous medium to prepare an emulsion. Suitable materials for use as the aqueous medium include water. In addition, organic solvents which can be mixed with water can be used in combination with water. Specific examples of such solvents include alcohols such as methanol, isopropanol, and ethylene glycol; dimethylformamide, tetrahydrofuran, cellosolves such as methyl cellosolve, lower ketones such as acetone and methyl ethyl ketone, etc.

In the aqueous medium, a precursor of a binder resin such as reactive modified polyester resins (e.g., polyester prepolymers (A) having an isocyanate group) is reacted with a compound reactive with the precursor such as amines (B) to produce a modified polyester resin (such as urea-modified polyester resins (UMPE)). In order to stably disperse a toner composition liquid including such a polyester prepolymer (A) and a urea-modified polyester resin (UMPE) in an aqueous medium, it is preferable to apply a shearing force to the mixture. The reactive modified polyester can be mixed with other toner constituents such as colorants, colorant master batches, release agents, charge controlling agents, unmodified polyester resins when the materials are dispersed in an aqueous medium to prepare a toner composition liquid. However, it is preferable that the reactive modified polyester and the other toner constituents are previously mixed, the mixture is dissolved or dispersed in a solvent to prepare a toner composition liquid, and then the toner composition liquid is dispersed in an aqueous medium. In addition, the toner constituents such as colorants, release agents and charge controlling agents are not necessarily mixed with other toner constituents when particles are formed in an aqueous medium, and can be mixed with the resultant toner particles formed in the aqueous medium. For example, a method in which after particles including no colorant are formed in an aqueous medium, the particles are dyed with a colorant using a known dyeing method can also be used.

Known dispersing machines can be used for emulsifying the toner composition liquid in an aqueous medium. Suitable dispersing machines include low speed shearing dispersion machines, high speed shearing dispersion machines, friction dispersion machines, high pressure jet dispersion machines, ultrasonic dispersion machines, etc. In order to prepare a dispersion having a particle diameter of from 2 μm to 20 μm, high speed shearing dispersion machines are preferably used.

When high speed shearing dispersion machines are used, the rotation number of the rotor is not particularly limited, but the rotation number is generally from 1,000 rpm to 30,000 rpm, and preferably from 5,000 rpm to 20,000 rpm. The dispersion time is not particularly limited. When a batch dispersion machines are used, the dispersion time is generally from 0.1 minutes to 5 minutes. The dispersion temperature is preferably from 0° C. to 150° C. and preferably from 40° C. to 98° C. It is preferable that dispersing is performed at a relatively high temperature because the dispersion has a low viscosity and thereby dispersing can be easily performed.

The weight ratio of the aqueous medium to the toner composition liquid including a polyester resin (such as UMPE and prepolymer (A)) is generally from 50/100 to 2,000/100 and preferably from 100/100 to 1,000/100. When the added amount of the aqueous medium is too low, the toner composition liquid cannot be well dispersed, and thereby toner particles having a desired particle diameter cannot be prepared. Adding a large amount of aqueous medium is not economical.

When the toner composition liquid is emulsified and dispersed in an aqueous medium, a dispersant such as surfactants, particulate inorganic dispersants, particulate polymer dispersants is preferably included in the aqueous medium to prepare a dispersion having good stability and including particles with a sharp particle diameter distribution.

Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

By using a fluorine-containing surfactant as the dispersant, good effects can be produced even when the added amount is small.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkyl(C7-C13) carboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl (C6-C10)-N-ethylsulfonylglycin, monoperfluoroalkyl(C6-C16)ethylphosphates, etc.

Specific examples of the marketed products of such surfactants include SARFRON S-111, S-112 and S-113, which are manufactured by Asahi Glass Co., Ltd.; FLUORAD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants having a fluoroalkyl group, which can disperse an oil phase including toner constituents in water, include primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SARFRON S-121 (from Asahi Glass Co., Ltd.); FLUORAD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Inorganic dispersants hardly soluble in water, such as tricalcium phosphate, calcium carbonate, titanium oxide, colloidal silica and hydroxyapatite can also be used.

Particulate polymers have the same effect as the particulate inorganic dispersants. Specific examples of the particulate polymers include particulate methyl methacrylate having a particle diameter of 1 μm or 3 μm, particulate polystyrene having a particle diameter of 0.5 μm or 2 μm, particulate styrene-acrylonitrile copolymers having a particle diameter of 1 μm (e.g., PB-200H from Kao Corp., SPG from Soken Chemical & Engineering Co., Ltd., TECHNOPOLYMER SB from Sekisui Plastic Co., Ltd., SGP-3G from Soken Chemical & Engineering Co., Ltd., and MICROPEARL from Sekisui Fine Chemical Co., Ltd.)

Further, it is preferable to stabilize the emulsion or dispersion using a polymer protection colloid in combination with the inorganic dispersants and particulate polymers.

Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

In order to reduce the viscosity of the toner composition liquid (i.e., oil phase liquid), solvents capable of dissolving polyesters such as urea-modified polyester resins and polyester prepolymers can be used. In this case, the resultant toner particles have a sharp particle diameter distribution. Suitable solvents include volatile solvents having a boiling point lower than 150° C., and preferably lower than 100° C., so as to be easily removed from the resultant toner particles. Specific examples of such volatile solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination. In particular, aromatic solvents such as toluene and xylene, and halogenated hydrocarbons such as methylene chloride, 1,2-dichloroethane, chloroform and carbon tetrachloride are preferably used. The weight ratio of the solvent to the polyester prepolymer is generally from 0/100 to 300/100, preferably from 0/100 to 100/100 and more preferably from 25/100 to 70/100. When a solvent is used, the solvent is removed from the reaction product under normal or reduced pressure after the molecular weight growth reaction and/or the crosslinking reaction of a modified polyester (i.e., a polyester prepolymer) with an amine.

The reaction time is determined depending on the reactivity of the isocyanate group of the polyester prepolymer with the reactive compound (such as amines) used, and is generally from 10 minutes to 40 hours, and preferably from 2 hours to 24 hours. The reaction temperature is generally from 0° C. to 150° C., and preferably from 40° C. to 98° C.

In addition, known catalysts such as dibutyltin laurate and dioctyltin laurate can be used, if desired, for the reaction. As mentioned above, amines (B) are typically used as the molecular weight growing agent and/or the crosslinking agent.

When preparing toner particles of the toner of the present invention, it is preferable that the reaction product, which has been subjected to a molecular weight growth reaction and/or a crosslinking reaction, is agitated at a temperature lower than the glass transition temperature of the binder resin included in the particles without evaporating the solvent included in the particles to prepare aggregated particles. After the resultant particles have the desired shape and particle size, the solvent is removed from the reaction product at a temperature of from 10 to 50° C. By performing agitation before the solvent removal operation, the particles are deformed.

The ratio (Dv/Dn) of the volume average particle diameter (Dv) of the toner to the number average particle diameter (Dn) thereof can be controlled by controlling factors such as viscosities of the aqueous phase liquid and oil phase liquid, and properties and added amount of the particulate resin included in the aqueous phase. In addition, the volume average particle diameter and the number average particle diameter of the toner can be controlled by controlling factors such as properties and added amount of the particulate resin included in the aqueous phase.

The toner of the present invention can be used for a two-component developer by being mixed with a magnetic carrier. In this case, the content of the toner is preferably from 1 part to 10 parts by weight per 100 parts by weight of a carrier.

Suitable carriers for use in the two component developer include known carrier materials such as iron powders, ferrite powders, magnetite powders, magnetic resin carriers, which have a particle diameter of from about 20 μm to about 200 μm. The surface of the carriers may be coated with a resin.

Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride—vinylfluoride copolymers, fluoroterpolymers (such as terpolymers of tetrafluoroethylene, vinylidenefluoride and other monomers including no fluorine atom), silicone resins, etc.

If desired, an electroconductive powder may be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is larger than 1 μm, it is hard to control the resistance of the resultant carrier.

The toner of the present invention can also be used as a one-component magnetic developer or a one-component non-magnetic developer, which includes no carrier.

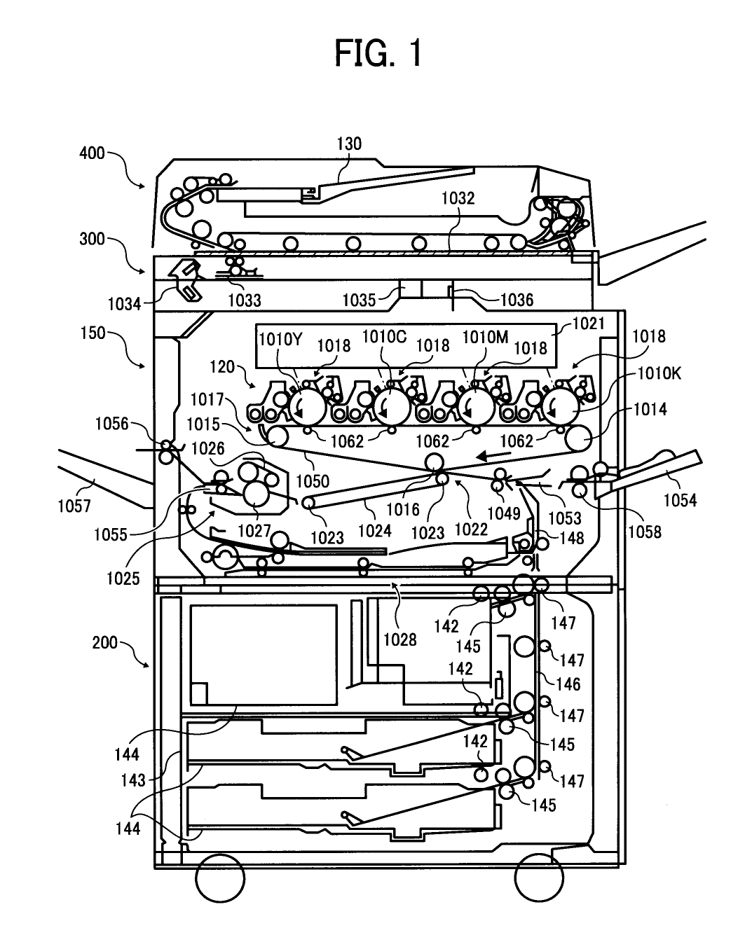

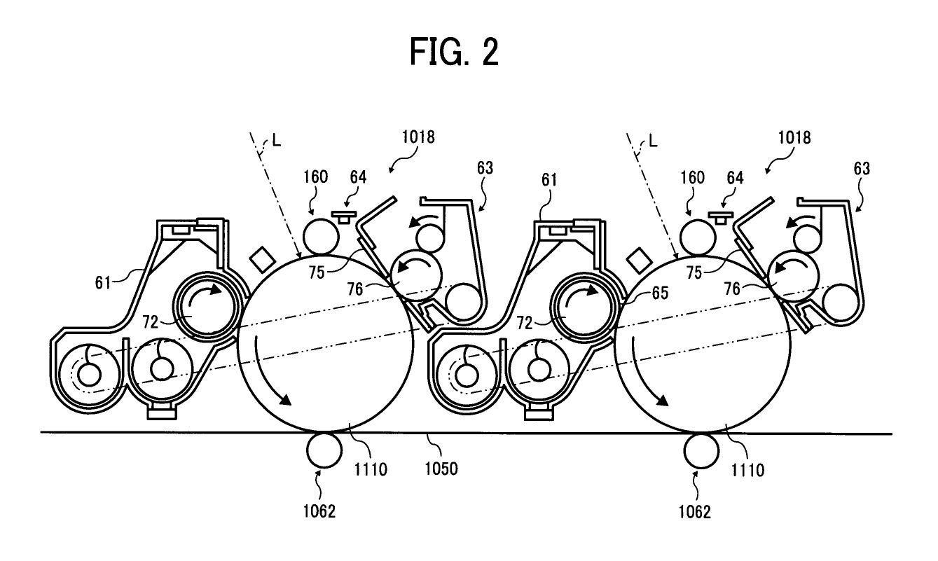

The image forming apparatus of the present invention will be explained by reference to FIGS. 1 and 2.

FIG. 1 is a schematic view illustrating a tandem color image forming apparatus, and FIG. 2 illustrates the image forming section of the tandem color image forming apparatus. The tandem color image forming apparatus includes a main body 150, a receiving material storing and feeding section 200, a scanner 300 and an automatic document feeder (ADF) 400.

In the main body 150, an intermediate transfer medium 1050 having an endless belt form is provided at the center of the main body. The intermediate transfer medium is clockwise rotated while tightly stretched by support rollers 1014, 1015 and 1016. An intermediate transfer medium cleaner 1017 is arranged in the vicinity of the support roller 1015 to remove toner particles remaining on the surface of the intermediate transfer medium even after a secondary image transfer process. An image forming section 120 is arranged along the part of the intermediate transfer medium, which part is supported by the support roller 1014 and 1015. The image forming section 120 includes four image forming devices 1018 for forming yellow, magenta, cyan and black images. Alight irradiating device 1021 is provided in the vicinity of the image forming section 120. A secondary image transfer device 1022 is provided on the side of the intermediate transfer medium opposite to the side facing the image forming devices. The secondary image transfer device 1022 includes a secondary transfer belt 1024 which is an endless belt and which is rotated while tightly stretched by two rollers 1023. A sheet of a receiving material, which has been fed from the receiving material storing and feeding section, is fed by the secondary transfer belt 1024 while contacted with the intermediate transfer medium 1050. A fixing device 1025 is provided in the vicinity of the secondary image transfer device 1022. The fixing device 1025 includes a fixing belt 1026 which is an endless belt, and a pressure roller 1027 pressed to the fixing belt.

The image forming apparatus includes a reversing device 1028, which is provided in the vicinity of the secondary image transfer device 1022 and the fixing device 1025 to reverse a sheet of the receiving material when a double-sided copy is produced.

Next, a full color image forming operation will be explained by reference to FIGS. 1 and 2.

When a color copy is produced by the image forming apparatus, at first an original is set on a table 130 of the ADF 400. Alternatively, an original is directly set on a glass plate 1032 of the scanner 300 after opening the ADF 400 and then the ADF is closed. When a start switch (not shown) is pressed, the original set on the table 130 is fed to the glass plate 1032 and then driving of the scanner 300 is started to read the image information of the original fed from the ADF or directly set on the glass plate 1032. Specifically, a first traveler 1033 starts to run and irradiates the surface of the original so that the light reflected from the original is fed toward a second traveler 1034, which also starts to run. The light reflected from a mirror of the second traveler 1034 is fed to the sensor 1036 through a focus lens 1035. Thus, the color image information of the original is read by the scanner 300. The color image information is converted to yellow, magenta, cyan and black image information.

The yellow, magenta, cyan and black image information is sent to the respective image forming devices 1018 of the image forming section 120, and the image forming devices form yellow, magenta, cyan and black toner images according to the information. The image forming devices 1018 include image bearing members 1010Y, 1010M, 1010C and 1010K for bearing thereon yellow, magenta, cyan and black images, respectively; chargers 160 configured to charge the surfaces of the respective image bearing members; developing devices 61 configured to develop electrostatic latent images, which are formed on the image bearing members by irradiating the charged image bearing members with image wise light L (illustrated in FIG. 2) to form yellow, magenta, cyan and black color toner images on the respective image bearing members 1010; transfer chargers 1062 configured to applying a transfer bias to the intermediate transfer medium to transfer the toner images on the image bearing members 1010 to the intermediate transfer medium 1050; cleaning devices 63 configured to clean the surface of the image bearing members using respective cleaning members 76 (such as cleaning brushes) and 75 (such as blades); and dischargers 64 configured to discharge charges remaining on the image bearing members even after the cleaning operation.

Electrostatic latent images formed on the image bearing members 1010 by the chargers 160 and the light irradiating device 1021 are developed with respective color developers, which includes respective color toners (each of which is the toner of the present invention) and which are borne on respective developing members 72. Thus, yellow, magenta, cyan and black toner images are formed on the respective image bearing members 1010Y, 1010M, 1010C and 1010K.

The yellow, magenta, cyan and black toner images thus prepared on the respective image bearing members 1010 are transferred onto the intermediate transfer medium 1050 one by one so as to be overlaid on the intermediate transfer medium (primary transfer process). Thus, a combined color image including yellow, magenta, cyan and black toner images is formed on the intermediate transfer medium 1050.

The receiving material storing and feeding section 200 includes plural cassettes 144 arranged one by one in a vertical direction in a receiving material bank 143. One of feeding rollers 142 is selectively rotated to feed an uppermost sheet of the receiving material sheets stored in the cassette. Each cassette includes a separating roller 145 configured to separate plural sheets of the receiving material and to feed the separated sheet to a feeding passage 146. The sheet is fed to a second feeding passage 148 by feeding rollers 147, and is stopped by a pair of registration rollers 1049 when reaches the registration rollers. Alternatively, sheets of the receiving material set on a manual tray 1054 may be fed to the registration rollers along a passage 1053 after being separated by separating rollers 1058.

In general, the pair of registration rollers 1049 are grounded. However, a bias can be applied to the pair of registration rollers to prevent adhesion of paper dust thereto.

The pair of registration rollers 1049 timely rotate to feed the sheet to a secondary transfer nip formed by the intermediate transfer medium 1050 and the secondary image transfer device 1022 so that the combined color toner image on the intermediate transfer medium 1050 is transferred to a proper portion of the sheet. Thus, a combined color toner image is formed on the sheet. Toner particles remaining on the intermediate transfer medium 1050 even after the secondary transfer operation are removed therefrom by the intermediate transfer medium cleaner 1017.

The receiving material sheet bearing the thus prepared combined color toner image thereon is then fed to the fixing device 1025 by the secondary image transfer device 1022. The color toner image is fixed to the sheet by the fixing device 1025 upon application of heat and pressure thereto. Then the sheet bearing a fixed color toner image thereon is discharged by a discharging roller 1056 to be stacked on a tray 1057. Alternatively, the sheet may be reversed by a switching pick 1055 to be fed again to the secondary transfer nip so that another toner image is formed on the opposite side of the sheet. In this case, after the toner image is fixed to the sheet by the fixing device 1025, the sheet is discharged by the discharging roller 1056 to be stacked on the tray 1057.

Next, the process cartridge of the present invention will be explained.

The process cartridge is detachably set in an image forming apparatus as a unit, and includes at least an image bearing member configured to bear an electrostatic latent image thereon, and a developing device configured to develop the electrostatic image with a developer including the toner of the present invention. The process cartridge can optionally include other devices such as charging devices configured to charge the image bearing member, light irradiating devices configured to irradiate the charged image bearing member with light to form an electrostatic image thereon, transfer devices configured to transfer a toner image on the image bearing member to a receiving material, cleaning devices configured to clean the surface of the image bearing member and discharging devices configured to discharge the charges remaining on the image bearing member.

The developing device of the process cartridge includes at least a developer containing portion containing a developer including the toner mentioned above, and a developer bearing member configured to bear the developer thereon to feed the developer to the image bearing member, and optionally includes a developer layer forming member configured to control the thickness of the developer borne on the developer bearing member.

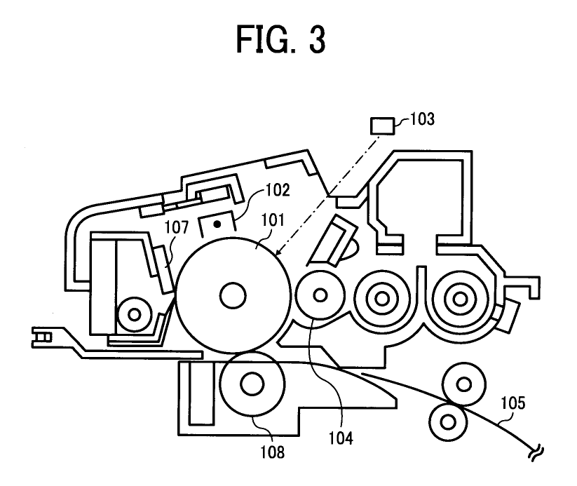

An example of the process cartridge is illustrated in FIG. 3. The process cartridge includes a photoreceptor 101 serving as an image bearing member, a charging device 102, a developing device 104, and a cleaning device 107. In FIG. 3, numerals 103, 105 and 108 denote imagewise light emitted by a light irradiating device, a receiving material, and a transfer roller serving a as a transfer device. Specific examples of the photoreceptor 101, the light irradiating device (103) and the charging device 102 include known devices for use in conventional image forming apparatuses and process cartridges.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### Preparation of Unmodified Polyester Resin

The following components were contained in a reaction vessel equipped with a condenser, a stirrer and a nitrogen feed pipe to perform a polycondensation reaction for 8 hours at 230° C. under normal pressure.

| | |
|---|---|
| Ethylene oxide (2 mole) adduct of | 690 parts |
| bisphenol A | |
| Terephthalic acid | 256 parts |

Then the reaction was further continued for 5 hours under a reduced pressure of from 10 to 15 mmHg (1332 to 1998 Pa). After the reaction product was cooled to 160° C., 18 parts of phthalic anhydride was added thereto, and the mixture was reacted for 2 hours. Thus, an unmodified polyester resin (1) was prepared. It was confirmed that the unmodified polyester resin (1) has a weight average molecular weight of 4,000, an acid value of 10 mgKOH/g and a glass transition temperature of from 50° C.

### (Preparation of Prepolymer)

The following components were contained in a reaction vessel equipped with a condenser, a stirrer, and a nitrogen feed pipe, and reacted for 8 hours at 230° C. under normal pressure.

| | | |
|---|---|---|
| Ethylene oxide (2 mole) adduct of | 800 | parts |
| bisphenol A | | |
| Isophthalic acid | 180 | parts |
| Terephthalic acid | 60 | parts |
| Dibutyltin oxide | 2 | parts |

Then the reaction was further continued for 5 hours under a reduced pressure of from 10 to 15 mmHg (1332 to 1998 Pa) while removing water generated by the reaction. After the reaction product was cooled to 160° C., 32 parts of phthalic anhydride was added thereto, and the mixture was reacted for 2 hours.

After the reaction product was cooled to 80° C., 170 parts of isophorone diisocyanate was reacted with the reaction product in ethyl acetate. Thus, a prepolymer (1) having an isocyanate group was prepared.

### (Synthesis of Ketimine Compound)

In a reaction vessel equipped with a stirrer and a thermometer, 30 parts of isophorone diamine and 70 parts of methyl ethyl ketone were mixed and reacted for 5 hours at 50° C. to prepare a ketimine compound (1).

### (Preparation of Wax Dispersion)

The following components were mixed.

| | | |
|---|---|---|
| Ethyl acetate | 70 | parts |
| Unmodified polyester 1 prepared above | 25 | parts |
| Paraffin wax | 5 | parts |
| (melting point of 68° C.) | | |

The mixture was then agitated for 24 hours using PAINT CONDITIONER NO. 5400 from RED DEVIL in which zirconia balls with a diameter of 3 mm are contained in a volume ratio of 60%. Thus, a wax dispersion 1 was prepared.

The volume average particle diameter of the wax in the wax dispersion 1, which was determined by a particle diameter distribution measuring instrument using a laser light scattering method, LA-920 from Horiba Ltd., was 0.21 μm.

### (Preparation of Particulate Resin Dispersion)

In a reaction vessel equipped with a stirrer and a thermometer, 683 parts of water, 20 parts of a sodium salt of sulfate of an ethylene oxide adduct of methacrylic acid (ELEMINOL RS-30 from Sanyo Chemical Industries Ltd.), 78 parts of styrene, 78 parts of methacrylic acid, 120 parts of butyl acrylate, and 1 part of ammonium persulfate were mixed. The mixture was agitated for 15 minutes while the stirrer was rotated at a revolution of 400 rpm. As a result, a milk-white emulsion was prepared. Then the emulsion was heated to 75° C. to react the monomers for 5 hours.

Further, 30 parts of a 1% aqueous solution of ammonium persulfate was added thereto, and the mixture was aged for 5 hours at 75° C. Thus, an aqueous dispersion of a particulate vinyl resin 1 (i.e., styrene-methacrylic acid-butyl acrylate-sodium salt of sulfate of an ethylene oxide adduct of methacrylic acid copolymer) was prepared. The volume average particle diameter (Dv) of the resin particles included in the particulate vinyl resin dispersion 1, which was measured with an instrument, NANOTRAC UPA-150 from Nikkiso Co., Ltd., was 55 nm.

### (Preparation of Aqueous Phase Liquid)

In a container equipped with a stirrer, 990 parts of water, 83 parts of the particulate resin dispersion 1, 37 parts of an aqueous solution of a sodium salt of dodecyldiphenyletherdisulfonic acid (ELEMINOL MON-7 from Sanyo Chemical Industries Ltd., solid content of 48.5%), and 90 parts of ethyl acetate were mixed while agitated. Thus, an aqueous phase liquid 1, which is a milk-white liquid, was prepared.

### (Preparation of Pigment Master Batch)

The following components were fed into a reaction vessel equipped with a condenser, an agitator, and a nitrogen feed pipe to be mixed, and the mixture was reacted for 8 hours at 230° C. under a normal pressure.

| | | |
|---|---|---|
| Propylene oxide (2 mole) adduct of | 319 | parts |
| bisphenol A | | |
| Ethylene oxide (2 mole) adduct of | 449 | parts |
| bisphenol A | | |
| Terephthalic acid | 243 | parts |
| Adipic acid | 53 | parts |
| Dibutyltin oxide | 2 | parts |

The reaction was further continued for 5 hours under a reduced pressure of from 10 to 15 mmHg (1332 to 1998 Pa). After the reaction product was cooled to 180° C., 7 parts of trimellitic anhydride was added thereto, and the mixture was reacted for 2 hours under a normal pressure. Thus, a polyester resin 1 for master batch (hereinafter referred to as a MB polyester resin 1) was prepared. It was confirmed that the MB polyester resin 1 has a number average molecular weight of 1,900, a weight average molecular weight of 6,100, a glass transition temperature of 43° C. and an acid value of 1.1 mgKOH/g.

The following components were mixed using a HENSCHEL MIXER mixer to prepare a mixture in which water is penetrated into the aggregated pigment.

| | |
|---|---|
| Water | 30 parts |
| C.I. Pigment Red 122 | 40 parts |
| (MAGENTA R from Toyo Ink Mfg Co., Ltd.) | |
| MB polyester resin | 60 parts |

The mixture was kneaded for 45 minutes at a temperature of 130° C. using a two-roll mill. The kneaded mixture was then cooled by rolling, followed by pulverization. Thus, a pigment master batch 1 was prepared.

### (Preparation of Layered Inorganic Material Master Batch)

The following components were mixed using a HENSCHEL MIXER mixer to prepare a mixture in which water is penetrated into the aggregated layered inorganic material (i.e., CLAYTON APA)

| | |
|---|---|
| Water | 30 parts |
| CLAYTON APA | 40 parts |
| (from Southern Clay Products Co., Ltd.) | |
| MB polyester resin | 60 parts |

The mixture was kneaded for 45 minutes at a temperature of 130° C. using a two-roll mill. The kneaded mixture was then cooled by rolling, followed by pulverization. Thus, a master batch 1 of the layered inorganic material (hereinafter referred to as an inorganic material master batch 1) was prepared.

### (Preparation of Oil Phase Liquid)

### Preparation of Pigment/Wax Dispersion

The following components were fed into a reaction vessel equipped with an agitator and a thermometer to be mixed.

| | | |
|---|---|---|
| Ethyl acetate solution of | 30 | parts |
| unmodified polyester resin 1 | | |
| (solid content of 65%) | | |
| Wax dispersion 1 | 50 | parts |
| Ethyl acetate solution of | 20 | parts |
| pigment master batch 1 | | |
| (solid content of 50%) | | |
| Inorganic material master batch 1 | 0.55 | parts |

The mixture was heated to 80° C., and the temperature was maintained for 5 hours while agitating, followed by cooling to 30° C. over 1 hour. Thus, a pigment/wax dispersion 1 was prepared.

### Preparation of Oil Phase Liquid 1

In a container, the following components were mixed for 1 minute using a TK HOMOMIXER mixer (from Tokushu Kika Kogyo Co. Ltd.) rotated at a revolution of 5,000 rpm.

| | | |
|---|---|---|
| Pigment/wax dispersion 1 | 664 | parts |
| Prepolymer 1 | 139 | parts |
| Ketimine compound 1 | 5.9 | parts |

Thus, an oil phase liquid 1 was prepared.

### (Preparation of Toner)

### Emulsification and Solvent Removal

Next, 1,200 parts of the aqueous liquid 1 was added to 808.9 parts of the oil phase liquid 1, and the mixture was agitated for 20 minutes using a TK HOMOMIXER mixer rotated at a revolution of 10,000 rpm. Thus, a dispersion (an emulsion slurry 1) was prepared.

Further, the emulsion slurry 1 was fed into a reaction vessel equipped with an agitator and a thermometer and heated for 8 hours at 30° C. to remove the solvent therefrom. Thus, a dispersion slurry 1 was prepared.

### Washing and Drying

One hundred (100) parts of the dispersion slurry 1 was filtered under a reduced pressure.

Next, the wet cake was mixed with 100 parts of ion-exchange water and the mixture was agitated for 10 minutes with a TK HOMOMIXER mixer rotated at a revolution of 12,000 rpm, followed by filtering. Thus, a wet cake (a) was prepared.

The thus prepared wet cake (a) was mixed with 100 parts of a 10% aqueous solution of sodium hydroxide, and the mixture was agitated for 30 minutes with a TK HOMOMIXER mixer at a revolution of 12,000 rpm, followed by filtering under a reduced pressure. Thus, a wet cake (b) was prepared.

The thus prepared wet cake (b) was mixed with 100 parts of a 10% aqueous solution of hydrochloric acid, and the mixture was agitated for 10 minutes with a TK HOMOMIXER mixer at a revolution of 12,000 rpm, followed by filtering. Thus, a wet cake (c) was prepared.

Then the wet cake (c) was mixed with 300 parts of ion-exchange water and the mixture was agitated for 10 minutes with a TK HOMOMIXER mixer at a revolution of 12,000 rpm, followed by filtering. This operation was repeated twice. Thus, a final wet cake 1 was prepared.

The final wet cake 1 was dried for 48 hours at 40° C. using a circulating air drier, followed by sieving with a screen having openings of 75 μm.

Thus, magenta toner particles were prepared.

One hundred (100) parts of the thus prepared toner particles was mixed with external additives, i.e., 0.5 parts of a hydrophobized silica, which had been prepared by treating the surface of a silica with hexamethyldisilazane and which has a specific surface area of 200 m²/g, and 0.5 parts of a hydrophobized rutile-form titanium oxide, which had been prepared by treating the surface of a titanium oxide with isobutyltrimethoxysilane and which has an average primary particle diameter of 0.02 μm, using a HENSCHEL MIXER mixer (from Mitsui Mining Co., Ltd.). Thus, a toner of Example 1 was prepared.

### Example 2

The procedure for preparation of the toner in Example 1 was repeated except that the pigment/wax dispersion 1 was replaced with a pigment/wax dispersion 2, the formula of which is as follows.

| | | |
|---|---|---|
| Ethyl acetate solution of | 30 | parts |
| unmodified polyester resin 1 | | |
| (solid content of 65%) | | |
| Wax dispersion 2 | 50 | parts |
| Ethyl acetate solution of | 20 | parts |
| pigment master batch 1 | | |
| (solid content of 50%) | | |
| Inorganic material master batch 1 | 0.55 | parts |

In this regard, the wax dispersion 2 was prepared in the same way as that of preparing the wax dispersion 1 except that the time of agitation using PAINT CONDITIONER NO. 5400 was changed from 24 hours to 18 hours, and the volume average particle diameter of the dispersed particles was 0.28 μm.

Thus, a toner of Example 2 was prepared.

### Example 3

The procedure for preparation of the toner in Example 1 was repeated except that the pigment/wax dispersion 1 was replaced with a pigment/wax dispersion 3, the formula of which is as follows.

| | | |
|---|---|---|
| Ethyl acetate solution of | 30 | parts |
| unmodified polyester resin 1 | | |
| (solid content of 65%) | | |
| Wax dispersion 3 | 50 | parts |
| Ethyl acetate solution of | 20 | parts |
| pigment master batch 1 | | |
| (solid content of 50%) | | |
| Inorganic material master batch 1 | 0.55 | parts |

In this regard, the wax dispersion 3 was prepared in the same way as that of preparing the wax dispersion 1 except that the time of agitation using PAINT CONDITIONER NO. 5400 was changed from 24 hours to 12 hours, and the volume average particle diameter of the dispersed particles was 0.39 μm.

Thus, a toner of Example 3 was prepared.

### Example 4

The procedure for preparation of the toner in Example 1 was repeated except that the pigment/wax dispersion 1 was replaced with a pigment/wax dispersion 4, the formula of which is as follows.

| | | |
|---|---|---|
| Ethyl acetate solution of | 30 | parts |
| unmodified polyester resin 1 | | |
| (solid content of 65%) | | |
| Wax dispersion 1 | 55 | parts |
| Ethyl acetate solution of | 20 | parts |
| pigment master batch 1 | | |
| (solid content of 50%) | | |
| Inorganic material master batch 1 | 0.55 | parts |

Thus, a toner of Example 4 was prepared.

### Example 5

The procedure for preparation of the toner in Example 1 was repeated except that the pigment/wax dispersion 1 was replaced with a pigment/wax dispersion 5, the formula of which is as follows.

| | | |
|---|---|---|
| Ethyl acetate solution of | 30 | parts |
| unmodified polyester resin 1 | | |
| (solid content of 65%) | | |
| Wax dispersion 2 | 55 | parts |
| Ethyl acetate solution of | 20 | parts |
| pigment master batch 1 | | |
| (solid content of 50%) | | |
| Inorganic material master batch 1 | 0.55 | parts |

Thus, a toner of Example 5 was prepared.

### Comparative Example 1

The procedure for preparation of the toner in Example 1 was repeated except that the pigment/wax dispersion 1 was replaced with a pigment dispersion 1, the formula of which is as follows.

| | | |
|---|---|---|
| Ethyl acetate solution of | 30 | parts |
| unmodified polyester resin 1 | | |
| (solid content of 65%) | | |
| Ethyl acetate solution of | 20 | parts |
| pigment master batch 1 | | |
| (solid content of 50%) | | |
| Inorganic material master batch 1 | 0.55 | parts |

In this regard, the pigment dispersion 1 was prepared in the same way as that of preparing the pigment/wax dispersion 1.

Thus, a toner of Comparative Example 1 was prepared.

### Comparative Example 2

The procedure for preparation of the toner in Example 1 was repeated except that the pigment/wax dispersion 1 was replaced with a pigment/wax dispersion 6, the formula of which is as follows.

| | |
|---|---|
| Ethyl acetate solution of | 30 parts |
| unmodified polyester resin 1 | |
| (solid content of 65%) | |
| Wax dispersion 1 | 50 parts |
| Ethyl acetate solution of | 20 parts |
| pigment master batch 1 | |
| (solid content of 50%) | |

Thus, a toner of Comparative Example 2 was prepared.

The thus prepared toners were evaluated as follows.

### 1. Concentration of Al in Surface Portion of Toner

Each toner was subjected to X-ray photoelectron spectroscopy (XPS) under the following conditions.
Instrument used: X-ray photoelectron spectrometer 1600S from PHI
X-ray source: MgKα (100 W)
Analysis area: 0.8 mm×2.0 mm

A sample was prepared by setting a toner on a carbon sheet set on a holder when the toner was subjected to XPS. In addition, the toner was kneaded for 30 minutes at 130° C. using a kneader, LABO PLATOMILL from Toyo Seiki Co., Ltd., whose rotor was rotated at a revolution of 70 rpm so that the toner constituents are evenly dispersed in the kneaded toner. The kneaded toner was pulverized and the pulverized toner was also set on a carbon sheet to be subjected to XPS.

Concentrations of atoms present in a surface portion of each of the toner and the kneaded/pulverized toner were determined on the basis of the strengths of the peaks of the XPS spectra and the data of the relative sensitivity factors provided by PHI. Since the layered inorganic material used includes Al, the concentration of Al was measured. In this regard, the more the difference between the concentration (C1) of Al in the surface portion of the toner and the concentration (C2) of Al in the surface portion of the kneaded/pulverized toner, the more eccentrically the modified layered inorganic material is present in a surface portion of the toner.

### 2. Amount of Wax Present in Surface Portion of Toner

The amount of the wax present in a surface portion of each toner was determined by a Fourier Transform Infrared Spectroscopy-Attenuated Total Reflection (i.e., FTIR-ATR). The measuring method is as follows.

At first, 3 g of a toner was set in an automatic palletizing machine (TYPE M No. 50 BRP-E from Maekawa Machine Co., Ltd. under the following conditions.

Load: 6 tons

Pressing time: 1 minute

The thus prepared pellet with a diameter of 40 mm and a thickness of about 2 mm was set in a FTIR device, combination of SPECTRUM ONE and MULTISCOPE FTIR unit from Perkin Elmer. The measurement conditions were as follows.

Crystal: Ge crystal with a diameter of 100 μm

Incident angle of IR: 41.5 degree

Resolution: 4 cm⁻¹

Number of accumulation: 20 times

Number of repeated measurements: 4 times (while changing the measuring point of the pellet)

Next, the ratio (P2850/P828) of the strength of the peak at 2850 cm⁻¹ (which is specific to the wax included in the toner) to the strength of the peak at 828 cm⁻¹ (which is specific to the binder resin included in the toner) was determined. In this regard, the greater the ratio (P2850/P828), the larger the amount of the wax present in the surface portion of the toner.

### 3. Amount of Wax Included in Toner

The amount of the wax included in the toner substantially depends on the amount of the wax used. However, there is a case where a wax used for granulating a toner in an aqueous medium is transferred into the aqueous medium, and thereby the amount of the wax included in the toner is decreased. Therefore, the amount of the wax included in each toner was determined on the basis of the amount of heat energy of the endothermic peak observed at the softening point (Tm) of the wax when the toner is subjected to differential scanning calorimetry. The softening point (Tm) is defined as the temperature at which the DSC curve has a maximum endothermic peak. A combination of TA-60WS and DSC-60 from Shimadzu Corp. was used as the measuring instrument. The measuring conditions are as follows.

Sample container: Aluminum pan with cap

Amount of sample: 5 mg

Reference sample: 10 mg of alumina contained in an aluminum pan

Atmosphere: Nitrogen (flow rate of 50 ml/min)

Temperature conditions

(First Temperature Rising Operation)

Starting temp.: 20° C.

Temp. rising speed: 10° C./min

End temp.: 150° C.

Retention time at end temp.: 0

(First Cooling Operation)

Cooling speed: 10° C./min

End temp.: 20° C.

Retention time at end temp.: 0

(Second Temperature Rising Operation)

Temp. rising speed: 10° C./min

End temp.: 150° C.

The measurement data were analyzed by an analyzing software TA-60 version 1.52 from Shimadzu Corp. The analysis was performed on the endothermic peak in the second temperature rising process.

The total amount (Awax) of the wax included in the toner is determined using the following equation (1):

Awax (% by weight)=Ht×100/Hw (1),

wherein Ht represents the heat quantity (in units of J/g) of the endothermic peak specific to the wax when the toner is subjected to DSC, and Hw represents the heat quantity (in units of J/g) of the endothermic peak specific to the wax when only the wax is subjected to DSC instead of the toner.

### 4. Particle Diameter of Toner

The particle diameter and particle diameter distribution of a toner were measured with a method using an instrument such as COULTER COUNTER TA-II and COULTER MULTISIZER II from Beckman Coulter Inc. In the present application, a system including COULTER COUNTER TA-II, an interface capable of outputting particle diameter distribution on number and volume basis (from Nikka Giken), and a personal computer PC9801 (from NEC) was used to determine the particle diameter and particle diameter distribution. Specifically, the procedure is as follows:
(1) a surfactant serving as a dispersant (preferably 0.1 to 5 ml of a 1% aqueous solution of an alkylbenzenesulfonic acid salt), is added to 100 ml to 150 ml of an electrolyte such as 1% aqueous solution of first class NaCl or ISOTON-II manufactured by Beckman Coulter Inc.;
(2) 2 to 20 mg of a sample to be measured is added into the electrolyte including the surfactant;
(3) the mixture is subjected to an ultrasonic dispersion treatment for about 1 to 3 minutes to disperse the sample in the electrolyte; and
(4) the volume-basis particle diameter distribution and number-basis particle diameter distribution of the sample are measured using the instrument in which the aperture is set to 100 μm.

In the present invention, the following 13 channels are used:

(1) not less than 2.00 μm and less than 2.52 μm;
(2) not less than 2.52 μm and less than 3.17 μm;
(3) not less than 3.17 μm and less than 4.00 μm;
(4) not less than 4.00 μm and less than 5.04 μm;
(5) not less than 5.04 μm and less than 6.35 μm;
(6) not less than 6.35 μm and less than 8.00 μm;
(7) not less than 8.00 μm and less than 10.08 μm;
(8) not less than 10.08 μm and less than 12.70 μm;
(9) not less than 12.70 μm and less than 16.00 μm;
(10) not less than 16.00 μm and less than 20.20 μm;
(11) not less than 20.20 μm and less than 25.40 μm;
(12) not less than 25.40 μm and less than 32.00 μm; and
(13) not less than 32.00 μm and less than 40.30 μm.

Namely, particles having a particle diameter of from 2.00 μm to 40.30 μm are targeted. The volume average particle diameter (Dv) and number average particle diameter (Dn) are determined from the volume-basis particle diameter distribution and the number-basis particle diameter distribution. In addition, the ratio (Dv/Dn) can be determined by calculation.

### 5. Circularity of Toner

The circularity of a particle is determined by the following equation:

Circularity=L1/L2,

wherein L2 represents the length of the circumference of the projected image of a particle and L1 represents the length of the circumference of a circle having the same area as that of the projected image of the particle. The average circularity of a toner can be determined by averaging the circularities of a number of toner particles of the toner.

The circularity of each toner was measured with a flow-type particle image analyzer FPIA-2000 from Sysmex Corp. The procedure thereof is as follows.

(1) at first 100 ml of water from which solid foreign materials have been removed, 0.5 ml of a surfactant (NEOGEN SC-A from Daiichi Kogyo Seiyaku Co., Ltd.), which serves as a dispersant and 0.5 g of a sample (i.e., toner) are mixed;
(2) the mixture is subjected to a supersonic dispersion treatment for about 3 minutes using a supersonic dispersion machine to prepare a dispersion including particles of the sample at a concentration of from 3,000 to 10,000 pieces/μl;
(3) the dispersion is passed through a detection area formed on a plate in the instrument; and
(4) the particles are optically detected by a CCD camera and then the shapes thereof are analyzed with an image analyzer, resulting in determination of the average circularity of the sample (toner).

When the circularity is 1.00, the toner has a true spherical form.

In this regard, by controlling the concentration of the dispersion in the above-mentioned range, the average circularity can be precisely determined.

### 6. Glass Transition Temperature (Tg)

The method for measuring the glass transition temperature (Tg) of a resin is measured by an instrument TG-DSC system TAS-100 manufactured by RIGAKU CORPORATION. The procedure for measurements of the glass transition temperature is as follows:
1) about 10 mg of a sample is contained in an aluminum container, and the container is set on a holder unit;
2) the holder unit is set in an electrical furnace, and the sample is heated from room temperature to 150° C. at a temperature rising speed of 10° C./min;
3) after the sample is allowed to settle at 150° C. for 10 minutes, the sample is cooled to room temperature; and
4) after the sample is allowed to settle at room temperature for 10 minutes, the sample is heated again from room temperature to 150° C. in a nitrogen atmosphere at a temperature rising speed of 10° C./min to perform a differential scanning calorimetric (DSC) analysis.

The glass transition temperature (Tg) of the sample is determined using an analysis system of the TAS-100 system. Namely, the glass transition temperature (Tg) is defined as the contact point between the tangent line of the endothermic curve at the temperatures near the glass transition temperature and the base line of the DSC curve.

### 7. Acid Value of Toner

The acid value of a toner is determined by the method described in JIS K0070-1992.

At first, about 0.5 g of a sample (resin), which is precisely measured, is mixed with 120 ml of tetrahydrofuran (THF) (or dioxane). The mixture is agitated for about 10 hours at room temperature (23° C.) to prepare a sample solution. The sample solution is subjected to titration using a N/10 alcohol solution of potassium hydroxide. The acid value (AV) of the sample is determined by the following equation.

AV=(KOH×N×56.1)/W

wherein KOH represents the amount (ml) of KOH consumed in the titration, N represents the factor of N/10 potassium hydroxide, and W represents the precise weight of the sample.

The instrument and measurement conditions are as follows.

Instrument: Automatic potentiometric titrator DL-53 (from Mettler Toledo K.K.)

Electrode: DG113-SC (from Mettler Toledo K.K.)

Analysis software: LabX Light Version 1.00.000

Calibration: A mixture solvent of 120 ml of toluene and 30 ml of ethanol is used.

Measurement temperature: 23° C.

Conditions of the instrument

Stir

Speed: 25%

Time: 15 sec

EQP Titration

Titrant/Sensor
Titrant: CH₃ONa
Concentration: 0.1 mol/L
Sensor: DG115
Unit of measurement: mV

Predispensing to Volume
Volume: 1.0 mL
Wait time: 0 sec

Titrant addition Dynamic
dE (set): 8.0 mV
dV (min): 0.03 mL
dV (max): 0.5 mL

Measure Mode Equilibrium Controlled
dE: 0.5 mV
dt: 1.0 sec
t(min): 2.0 sec
t(max): 20.0 sec

Recognition
Threshold: 100.0
Steepest jump only: No
Range: No
Tendency: None

Termination
At maximum volume: 10.0 ml
At potential: No
At slope: No
After number EQPS: Yes
   n=1
Comb. Termination conditions: No

Evaluation
Procedure: Standard
Potential 1: No
Potential 2: No
Stop for reevaluation: No

### 8. Quality (Granularity and Sharpness) of Image

A two-component developer including the toner and a carrier was set in a digital full color copier IMAGIO COLOR 2800 from Ricoh Co., Ltd., and monochrome copies of an original image were produced. The produced images were visually observed to grade the images with respect to granularity and sharpness.

The image quality is graded as follows.

⊚: The image quality thereof is almost the same as that of images produced by offset printing.
◯: The image quality thereof is slightly worse than that of images produced by offset printing.
Δ: The image quality thereof is worse than that of images produced by offset printing.
X: The image quality thereof is almost the same as that of images produced by conventional electrophotographic image forming apparatuses.

### 9. Background Development

Each developer was set in a digital full color copier IMAGIO COLOR 2800 from Ricoh Co., Ltd., and 30,000 monochrome copies of an original image with image area proportion of 50% were produced. After the running test, a white image was produced. When a latent image of the white image was developed, the image forming apparatus was turned off before the image transfer operation is stated. The toner particles on the photoreceptor (i.e., toner particles in a white image area) were transferred to an adhesive tape. The blank adhesive tape and the adhesive tape bearing the toner particles thereon were adhered on a white paper to determine the difference in optical density between the blank adhesive tape and the adhesive tape bearing the toner particles thereon. The optical density was measured by a spectrodensitometer 938 manufactured by X-Rite Inc. Background development is graded as follows.

⊚: The difference in density is little.
◯: The difference in density is small.
Δ: The difference in density is slightly large.
X: The difference in density is large.

### 10. Fixability (Low Temperature Fixability and Hot Offset Resistance)

Each developer was set in an image forming apparatus, IMAGIO MF2200 manufactured by Ricoh Co., Ltd., which is modified such that a TEFLON roller is used as the fixing roller. Copies of an image were produced using a receiving paper TYPE 6200 from Ricoh Co., Ltd., while the fixing temperature was changed to evaluate the low temperature fixability (i.e., the cold offset temperature) and the hot offset resistance (i.e., the hot offset temperature) of the toner.

Specifically, the cold offset temperature is determined as follows.

1) The toner images fixed at different fixing temperatures are carefully observed to determine whether a cold offset phenomenon occurs.

In this regard, the fixing conditions are as follows.

Fixing speed: 120 to 150 mm/sec

Fixing pressure: 1.18×10⁵ Pa (1.2 Kgf/cm²) in surface pressure

Fixing nip width: 3 mm.

The cold offset temperature is defined as a fixing temperature below which a cold offset phenomenon is observed in the fixed images.

The low temperature fixability is graded as follows.

⊚: The cold offset temperature is lower than 140° C.,
◯: The cold offset temperature is from 140° C. to 149° C.
Δ: The cold offset temperature is from 150° C. to 159° C.
X: The cold offset temperature is not lower than 160° C.

Conventional low temperature fixable toners typically have a cold offset temperature of from about 140 to about 150° C.

The hot offset temperature is determined as follows.

1) The images fixed at different fixing temperatures are carefully observed to determine whether a hot offset phenomenon occurs.

The hot offset temperature is defined as a fixing temperature above which a hot offset phenomenon is observed in the fixed images.

In this regard, the fixing conditions were as follows.

Fixing speed: 50 mm/sec

Fixing pressure: 1.96×10⁵ Pa (2.0 Kgf/cm²) in surface pressure

Fixing nip width: 4.5 mm.

The hot offset resistance is graded as follows.

⊚: The hot offset temperature is not lower than 201° C.,
◯: The hot offset temperature is from 191° C. to 200° C.
Δ: The hot offset temperature is from 181° C. to 190° C.
X: The hot offset temperature is not higher than 180° C.

### 11. High Temperature Preservability

After each toner is allowed to settle at 50° C. for 8 hours, the toner is sieved for 2 minutes with a screen with openings of 42 mesh to determine the following residual ratio (R):

R (%)=(Wr/Wt)×100

wherein Wr represents the weight of the toner particles remaining on the screen, and Wt represents the total weight of the sieved toner.

The high temperature preservability is graded as follows.

⊚: The residual ratio is less than 10%.
◯: The residual ratio is not less than 10% and less than 20%.
Δ: The residual ratio is not less than 20% and less than 30%.
X: The residual ratio is not less than 30%.

In this regard, the lower residual ratio a toner has, the better high temperature preservability the toner has.

The results are shown in Table 1.

TABLE 1

| | | | | | | Comp. | Comp. |
|---|---|---|---|---|---|---|---|
| | Ex. 1 | Ex. 2 | Ex. 3 | Ex. 4 | Ex. 5 | Ex. 1 | Ex. 2 |
| Conc. (C1) of Al | 0.62 | 0.64 | 0.61 | 0.59 | 0.61 | 0.63 | 0 |
| (atomic %) | | | | | | | |
| Conc. (C2) of Al | 0.44 | 0.46 | 0.44 | 0.42 | 0.44 | 0.45 | 0.00 |
| (atomic %) | | | | | | | |
| P2850/P828 | 0.032 | 0.041 | 0.055 | 0.061 | 0.073 | 0 | 0.156 |
| Amount of wax (%) | 4.5 | 4.5 | 4.5 | 5 | 5 | 0 | 4 |
| Amount of modified | 1.00 | 1.00 | 1.00 | 1.00 | 1.00 | 1.00 | 0.00 |
| layered inorganic | | | | | | | |
| material (%) | | | | | | | |
| Dv (μm) | 5.3 | 5.1 | 5.2 | 5.2 | 5.3 | 5.1 | 5.1 |
| Dv/Dn | 1.14 | 1.14 | 1.15 | 1.15 | 1.14 | 1.14 | 1.13 |
| Circularity | 0.956 | 0.955 | 0.961 | 0.957 | 0.960 | 0.951 | 0.982 |
| Tg (° C.) | 50.1 | 50.3 | 49.9 | 50.2 | 50.3 | 50.1 | 50.3 |
| Acid value | 8 | 8 | 8 | 8 | 8 | 9 | 8 |
| (mgKOPH/g) | | | | | | | |
| Low temp, | ◯ | ◯ | ◯ | ◯ | ◯ | X | ◯ |
| fixability | | | | | | | |
| Hot offset | ◯ | ◯ | ◯ | ◯ | ◯ | X | ◯ |
| resistance | | | | | | | |
| Preservability | ◯ | ◯ | ◯ | ◯ | ◯ | ◯ | ◯ |
| Background | ◯ | ◯ | ◯ | ◯ | ◯ | X | X |
| development | | | | | | | |
| Image quality | ◯ | ◯ | ◯ | ◯ | ◯ | X | X |

It is clear from Table 1 that the toners of Examples 1 to 5 have a good combination of image qualities (such as granularity, sharpness and background development), preservability and fixing properties.

This document claims priority and contains subject matter related to Japanese Patent Application No. 2007-068455, filed on Mar. 16, 2007, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
toner particles including:
a binder resin;
a colorant;
a release agent; and
a modified layered inorganic material in which at least part of interlayer ions is modified with an organic ion,
wherein the toner includes the release agent in an amount of from 3 to 6% by weight based on a total weight of the toner, and concentration of the modified layered inorganic material in a surface portion of the toner is greater than average concentration thereof in the toner, and wherein the toner satisfies the following relationship:
0.03≦(P2850/P828)≦0.10,
wherein P2850 and P828 represent strengths of peaks observed at wavenumbers of 2850 cm⁻¹ and 828 cm⁻¹, respectively, when the toner is subjected to Fourier Transform Infrared Spectroscopy-Attenuated Total Reflection (FTIR-ATR).

2. The toner according to claim 1, wherein the toner particles are prepared by a method including:
emulsifying or dispersing a toner composition including at least the binder resin, the colorant, the release agent and the modified layered inorganic material in an aqueous medium.

3. The toner according to claim 1, wherein the toner particles are prepared by a method including:
dissolving or dispersing a toner composition including at least a precursor of the binder resin or the binder resin, and the colorant, the release agent and the modified layered inorganic material in a solvent to prepare an oil phase liquid;
dispersing the oil phase liquid in an aqueous medium to prepare an emulsion;
optionally heating the emulsion to change the precursor to the binder resin; and
removing the solvent from the emulsion to prepare a dispersion of the toner particles.

4. The toner according to claim 1, wherein the toner particles are prepared by a method including:
dissolving or dispersing at least the colorant, the release agent and the modified layered inorganic material in a precursor of the binder resin to prepare an oil phase liquid;
dispersing the oil phase liquid in an aqueous medium to prepare an emulsion; and
heating the emulsion to change the precursor to the binder resin and to prepare a dispersion of the toner particles.

5. The toner according to claim 1, wherein the release agent includes a hydrocarbon wax.

6. The toner according to claim 1, wherein the modified layered inorganic material includes a modified layered clay in which at least part of interlayer ions is modified with an organic ion, and wherein the toner includes the modified layered clay in an amount of from 0.05% to 5.0% by weight based on a total weight of the toner.

7. The toner according to claim 1, wherein the toner has an average circularity of from 0.93 to 0.97.

8. The toner according to claim 1, wherein the toner has a volume average particle diameter of from 3.0 μm to 7.0 μm.

9. The toner according to claim 1, wherein the toner has an acid value of from 0.5 mgKOH/g to 40.0 mgKOH/g.

10. The toner according to claim 1, wherein the toner has a glass transition temperature of from 40 to 70° C.

11. An image forming apparatus comprising:
an image bearing member configured to bear an electrostatic image thereon;
a developing device configured to develop the electrostatic image with a developer including the toner according to claim 1 to form a toner image on the image bearing member;
a transfer device configured to transfer the toner image on a receiving material optionally via an intermediate transfer medium; and
a fixing device configured to fix the toner image on the receiving material.

12. A process cartridge comprising:
an image bearing member configured to bear an electrostatic image thereon; and
a developing device configured to develop the electrostatic image with a developer including the toner according to claim 1 to form a toner image on the image bearing member,
wherein the process cartridge is detachably attached to an image forming apparatus as a unit.
